(19) United States
(12) Patent Application Publication
(10) Pub. No.: US 2022/0351653 A1
(43) Pub. Date: Nov. 3, 2022

(54) SYSTEM AND METHOD FOR AUGMENTING LIGHTFIELD IMAGES

(71) Applicant: Looking Glass Factory, Inc., Brooklyn, NY (US)

(72) Inventors: Alexis Hornstein, Brooklyn, NY (US); Shawn Michael Frayne, Brooklyn, NY (US); Lee Shiu Pong, Brooklyn, NY (US); Matthew Collins, Brooklyn, NY (US); Caleb Johnston, Brooklyn, NY (US)

(21) Appl. No.: 17/864,844

(22) Filed: Jul. 14, 2022

Related U.S. Application Data
(63) Continuation of application No. 17/535,449, filed on Nov. 24, 2021.
(60) Provisional application No. 63/179,952, filed on Apr. 26, 2021.
(60) Provisional application No. 63/117,614, filed on Nov. 24, 2020.

(51) Int. Cl. G09G 3/00; G06T 7/30; G06T 7/50; G06T 15/40; G02B 30/27; G06T 7/70

(52) U.S. Cl. CPC G09G 3/003; G06T 7/30; G06T 7/50; G06T 15/40; G02B 30/27; G06T 7/70; G06T 2207/10052

(57) ABSTRACT

A system or method for augmenting a lightfield image can include receiving a plurality of images of a subject, overlaying augmentation content on the images, optionally obscuring portions of the augmentation content based on the perspective of the image and the subject, and displaying the aligned images and the augmentation content at a holographic display.

### CROSS-REFERENCE TO RELATED APPLICATIONS

This application is a continuation of US application Ser. No. 17/535,449, filed on 24 Nov. 2021, which claims the benefit of U.S. Provisional Application No. 63/179,952, filed 26 Apr. 2021 and US Provisional No. 63/117,614, filed 24 Nov. 2020, each of which is incorporated in its entirety by this reference.

### TECHNICAL FIELD

This invention relates generally to the lightfield image generation field, and more specifically to a new and useful system and method in the lightfield image generation field.

### BACKGROUND

Typically, to augment a lightfield image, depths to features within the images need to be known or determined. However, determining the depths can require significant processing power, can result in incomplete information (e.g., resulting from obscuration), and/or can otherwise hinder the augmentation of the lightfield image. Trying to augment images with digital content without the depth information can lead to artifacts where portions of the digital content that are expected to be obscured are overlaid on the lightfield image. Thus, there is a need in the lightfield image field to create a new and useful system and method. This invention provides such a new and useful system and method.

### BRIEF DESCRIPTION OF THE FIGURES

FIG. 1 is a schematic representation of the system.

FIG. 2 is a schematic representation of the method.

FIGS. 3A and 3B are schematic representations of an example of augmenting a lightfield image with digital content in the foreground.

FIG. 4 is a schematic representation of an example of augmenting a lightfield image with digital content that is partially occluded by a subject of the lightfield image.

FIG. 5 is a schematic representation of an example of refining an augmented lightfield image.

FIG. 6 is a schematic representation of a variant of the method.

FIG. 7 is an illustrative example of the method.

FIG. 8 is a schematic representation of an example of augmenting a lightfield photoset with augmentation content in front of a focal plane of the lightfield image.

FIG. 9 is a block chart representation of an example of augmenting a lightfield photoset with augmentation content in front of a focal plane of the lightfield image.

FIG. 10 is a block chart representation of an example of augmenting a lightfield photoset with augmentation content in front of and behind a focal plane of the lightfield image.

FIG. 11 is a render of an example artifact that can be observed when augmentation is applied to a view of a lightfield image.

FIG. 12 is a schematic representation of an example of augmenting a lightfield image during a teleconferencing situation.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. Overview.

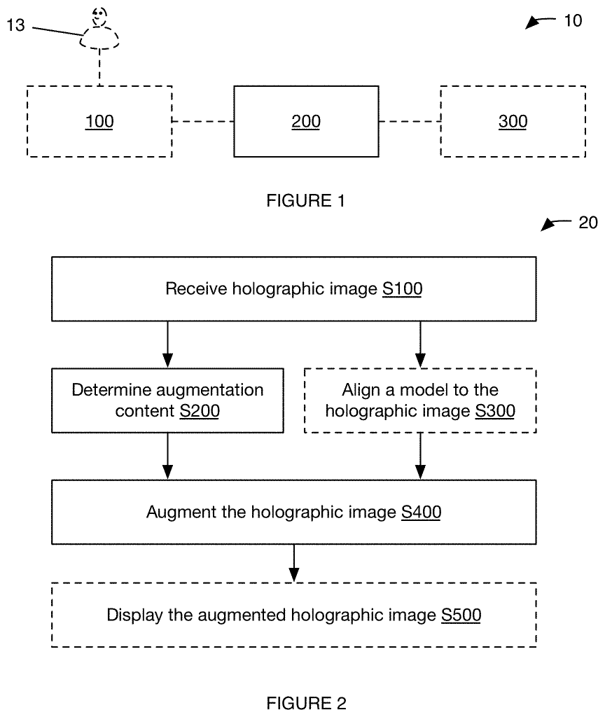

As shown in FIG. 1, the system 10 can include a computing system 200. The system can optionally include an image acquisition system 100, a display 300, and/or any suitable components.

As shown in FIG. 2, the method 20 can include receiving a lightfield image S100, determining augmentation content S200, augmenting the lightfield image S400. The method can optionally include aligning a model to the lightfield image S300, displaying the lightfield image S500, and/or any suitable steps.

The system and method function to generate and/or augment a lightfield image. The lightfield image preferably includes one or more subjects 13 (e.g., focal point(s) or point(s) of interest such as humans, animals, plants, etc.; objects; etc.) but can be a subject-less scene (e.g., a featureless scene, backgrounds, landscapes, buildings, a scene without a focal point or point of interest, etc.). The system and method preferably augment the lightfield image (e.g., the subject(s), object(s), etc. of the lightfield image) with augmentation content (e.g., digital content). However, the system and method can additionally or alternatively edit (e.g., smooth, filter, color shift, etc.), label, modify, change (e.g., remove a background, use a virtual background, change a foreground, add a transparent foreground, add effects, add characters, etc.), combine two or more subjects into a single lightfield image (e.g., by treating one or more subjects as augmentation content to be applied to a lightfield image of another subject), and/or otherwise augment the lightfield image.

### 2. Benefits.

Variations of the technology can confer several benefits and/or advantages.

First, variants of the technology can enable real- or near-real time (e.g., during telecommunication, as a subject is traversing an environment, contemporaneously with image acquisition or model generation, as shown for example in FIG. 12, etc.) augmentation of a lightfield image. In an illustrative example, during communications between two (or more) users, one (or more) of the users can augment the communication sent from them. For instance, the user(s) can remove or change their background, add content to facilitate collaboration or communication (e.g., adding labels), add an effect, and/or otherwise augment the communication. These variants can be enabled, for instance, by augmenting the views (e.g., images) that make up the lightfield image without depth information about the subject or scene (e.g., without determining a depth of the views, without generating a three dimensional representation of the scene, etc. which are frequently computationally intensive and can therefore be prohibitive to perform in real or near-real time for telecommunications). However, these variants can otherwise be enabled.

Second, variants of the technology can decrease (and/or minimize or prevent) the appearance of artifacts 290 (such as when the augmentation content is not occluded as expected). By way of illustrative example as shown in FIG. 1i, when the augmentation content includes a pair of glasses an artifact can occur where the temples of the glasses appear in front of a user's face (rather than appearing occluded as one would normally expect). In specific examples, artifacts can be avoided or decreased by using a model or other clipping mask to indicate portions of the augmentation content to be modified. However, artifacts can otherwise be decreased.

However, variants of the technology can confer any other suitable benefits and/or advantages.

### 3. System.

The system can function to acquire lightfield images (e.g., views associated therewith), determine augmentation content, augment lightfield images, and/or otherwise function.

The optional image acquisition system 100 functions to acquire images of a photoset (e.g., a photoset associated with or used to generate a lightfield image 16o). The image acquisition system preferably includes a plurality of cameras, but can include a single camera and/or any suitable image sensors. The camera(s) 150 can be a pinhole camera, a plenoptic camera (e.g., a lightfield camera), a single lens reflex (SLR) camera (e.g., a digital single lens reflex (DSLR) camera), a point-and-shoot camera, a digital camera, a field camera, a press camera, a rangefinder camera, a still camera, twin lens reflex (TLR) camera, a depth camera, a thermal camera, and/or any suitable type of camera. Each camera can be fixed (e.g., be mounted to have a static relation orientation, static absolute orientation, etc.) or moveable. The number of cameras in the image acquisition system is preferably the same as the number of views in the lightfield image. However, the number of cameras in the image acquisition system can be less than the number of views (e.g., when one or more cameras are mounted on a gantry, track, robot, motor, and/or other movement system and acquire images from more than one perspective, when one or more intermediate views are interpolated or generated, etc.) or greater than the number of views (e.g., to provide redundancy; to provide options for different perspectives such as above, below, wide view, narrow view, etc.; etc.).

The camera array can be a one-dimensional camera array (e.g., where the image sensor for each camera of the camera array is aligned to a reference axis such as a horizontal reference axis, a vertical reference axis, a straight reference line, a curved reference line, along an edge of a display, etc.), a two dimensional camera array (e.g., where the cameras are arranged on a two-dimensional grid, a rectilinear grid, a curvilinear grid, etc.), a three dimensional camera array (e.g., where the cameras are placed with a predetermined arrangement in three dimensional space; to match a pixel or screen shape such as to define a spherical spatial distribution to match a spherical screen or pixel of a display; etc.), and/or otherwise be arranged. The number of cameras in the camera array can depend on viewer parameters (e.g., the number of viewers; the distance such as an average distance, optimal viewing distance, focal distance, maximal distance, minimal distance, etc. between the viewer and the display; etc.), an environmental parameter (e.g., a distance of a subject from the image capture system, a number of subjects, etc.), views (e.g., the number of views that can be displayed, the number of views that need to be displayed for the viewers to perceive the scene as three dimensional or with predetermined quality, etc.), a camera parameter (e.g., the camera frame rate, the camera resolution, the camera field of view, a stereo-camera baseline, frame rate, image resolution, etc.), a computing system property (e.g., bandwidth of information transfer, processing bandwidth, etc.), and/or depend on any property.

Each camera is preferably synchronized (e.g., acquires an image and/or frame within 100 ms of the other cameras), but the cameras can be unsynchronized. The image size (e.g., view size, image resolution, etc.) is preferably the same for each camera (e.g., same size optical sensor for each camera, same pixel pitch, same pixel arrangement, etc.), but can be different (e.g., different optical sensor for each camera, different pixel pitch, different pixel arrangement, etc.). The image acquisition system is preferably calibrated (e.g., camera pose for each camera known, intrinsic parameters for each camera known, extrinsic parameters for each camera known, etc.), but can be uncalibrated. In a first example an image acquisition system can be a camera array such as a camera array as disclosed in US patent application No. 17/073,927, filed 19-Oct.-2020 titled “SYSTEM AND METHOD FOR LIGHTFIELD CAPTURE” which is incorporated in its entirety by this reference. In a second example an image acquisition system can be a camera (or plurality of cameras) that are mounted on a rail (or otherwise configured to move along a predetermined path) that captures images at predetermined positions, at predetermined times, or otherwise captures images along the path. In a third example, an image acquisition system can be a camera of a user device (e.g., smart phone), where the images are captured with free motion of the camera. However, any image acquisition system can be used.

The optional display(s) 300 functions to display lightfield images (and/or holographic videos). The display can optionally display any suitable image and/or view. The displayed lightfield image(s) are preferably perceived as three dimensional (3D), but can additionally or alternatively be 2.5 D, 2D, 1D, and/or have any suitable appearance. The lightfield images are preferably perceived as 3D without the use of a headset or auxiliary equipment (e.g., without using stereoscopic glasses). However, the lightfield images can be perceived as (and/or perception can be enhanced by) 3D using a headset or auxiliary equipment and/or otherwise be perceived as 3D. The display is preferably configured to display the lightfield images to a plurality of viewers (e.g., without requiring any viewers to have a headset or auxiliary equipment), but can be configured to display the lightfield images to a single viewer, and/or to any suitable viewers. The display can include one or more: light sources, optical elements (e.g., lenses; polarizers; waveplates; filters such as neutral density filters, color filters, etc.; beam steerers; liquid crystals; etc.), parallax generators, optical volumes, and/or any suitable components. In specific examples, the display can be as any suitable display as disclosed in U.S. Pat. No. 10,191,295 entitled ‘ADVANCED RETROREFLECTING AERIAL DISPLAYS’ filed on 05-Jan.-2018, US patent application Number 1₇/328,076 entitled ‘SUPERSTEREOSCOPIC DISPLAY WITH ENHANCED OFF-ANGLE SEPARATION’ filed on 24 May 2021, US patent application Number 1₇/326,857 entitled ‘SYSTEM AND METHOD FOR HOLOGRAPHIC IMAGE DISPLAY’ filed on 21 May 2021, and/or US patent application No. 17/332,479 entitled ‘SYSTEM AND METHOD FOR HOLOGRAPHIC DISPLAYS’ filed 27MAY 2021, each of which is incorporated herein in its entirety by this reference. In an illustrative example, a display can include a light source (e.g., a pixelated light source, LED, OLED, etc.), a parallax generator (e.g., lenticular lens, 1D lenticular lens, parallax barrier, etc.) optically coupled to the light source that, with the light source, generates a light output having viewing angle dependency; and an optical volume optically coupled to the lenticular lens.

The display can be a single focal plane display or a multifocal plane display (e.g., a display that includes a reflector to introduce a second focal plane, a display with any number of focal planes, etc.). When the display is a multifocal plane display, a plurality of features can be focused (e.g., each focal plane of the multifocal plane display). The focal plane preferably refers to a zero or near zero parallax point of the display, but can otherwise be defined. The focal plane(s) can depend on the display size, pixel pitch, parallax generator pitch, lenticular focal length, and/or depend on any suitable characteristics of the display.

However, any display can be used.

In variants including a plurality of displays (e.g., when augmented lightfield images are transmitted to a plurality of displays), each display can be the same or different from the other displays.

In variants where a display and image acquisition system are connected or otherwise collocated, the image acquisition system is preferably mounted above the display, but can be mounted along a side of the display, along a bottom of the display, within the display region (e.g., cameras can be embedded proximal the light source), separate from the display (e.g., mounted in the same environment such as within a threshold distance of the viewer and with an arbitrary or semi-arbitrary arrangement or distance from the display), and/or can otherwise be arranged.

The computing system 200 can function to generate lightfield image(s) and/or video(s), process a lightfield image (and/or views thereof), augment the lightfield image, determine augmentation content, control the image acquisition system and/or display, and/or perform any function(s). The computing system can be local (e.g., to the image acquisition system, to a camera of the image acquisition system, to each camera of the image acquisition system, to a display, etc.), remote (e.g., cloud computing, server, network, etc.), and/or distributed (e.g., between a local and a remote computing system). The computing system can be in communication with the image acquisition system, a subset of cameras of the image acquisition system, the display(s), and/or with any suitable components. The computing system can include: a rendering engine (e.g., functional to render a model, augmentation content, 3D content, etc. such as by rasterizing, ray casting, ray tracing, using a rendering equation, etc.), an augmentation engine (e.g., functional to determine, generate, etc. augmentation content such as building a 3D model using modeling software, 3D scanning, 2D scanning, procedural modelling, manual modelling, etc.), a feature engine (e.g., functional to detect one or more features, objects, subjects, etc. within an image such as using SIFT, SURF, ORB, BRISK, BRIEF, machine learning algorithms, etc.), an alignment engine (e.g., functional to align the images for instance by setting a shared feature to near zero disparity; by setting a bounding box around a feature in each image and cropping the images to the bounding box; using a machine learning algorithm; as disclosed in US Provisional Application No. 63/120,034, titled ‘SYSTEM AND METHOD FOR PROCESSING HOLOGRAPHIC IMAGES’ filed 01-Dec.-2020, and/or any patent application which claims the benefit of or priority to said provisional application, which are each incorporated in their entirety by this reference; etc.), and/or any suitable engines, modules, and/or algorithms. The computing system can include a single board computer (e.g., a Raspberry Pi™, Data General Nova, etc.), microprocessor, graphics processing unit, central processing unit, multi-core processor, vision processing unit, tensor processing unit, neural processing unit, physics processing unit, digital signal processor, image signal processor, synergistic processing unit, quantum processing unit, and/or any suitable processor(s) or processing unit(s).

The optional sensors function to determine one or more characteristics of a scene (e.g., a scene proximal the image acquisition system). The sensors can additionally or alternatively function to determine characteristics of and/or changes in the system. Examples of characteristics of the scene can include separation distance between one or more feature (e.g., between subjects) in the scene and one or more camera of the image acquisition system, sound generated from one or more features (e.g., to acquire audio to be synchronized or otherwise played with the lightfield image or video), motion of one or more feature, location of one or more feature, illumination (e.g., how bright is a scene, how is the scene lighted, etc.), depth (e.g., a depth sensor to determine a separation distance between a feature and the image acquisition system, to determine a depth to a focal plane, etc.), and/or any suitable characteristics. Examples of characteristics of the system can include: camera pose (e.g., location, orientation, etc. for image acquisition system and/or each camera in the array), obscuration of one or more cameras, computer speed (e.g., communication speed), memory limits, changes in connection, type of display, number of displays, and/or any suitable system characteristics. Examples of sensors can include: spatial sensors (e.g., ultrasound, optical, radar, etc.), acoustic sensors (e.g., microphones, speakers, etc.), light sensors (e.g., photodiodes), tracking sensors (e.g., head trackers, eye trackers, face trackers, camera, etc.), depth sensors (e.g., time of flight sensors, LIDAR, projected light sensors, SONAR, RADAR, depth camera, etc.), and/or any suitable sensor.

In some variants, one or more cameras from the image acquisition system can be used as sensors. In a specific example, two cameras from the image acquisition system can be used to collect stereoscopic images of a scene, wherein the stereoscopic images can be used to determine depth information (e.g., a depth map) for the scene (e.g., based on a pose or orientation between the cameras). However, the camera(s) can be used as sensors in any suitable manner.

In a first specific example, the system can be integrated into a common housing (e.g., with a footprint or form factor comparable to a smart phone, tablet, laptop, and/or any suitable footprint or form factor such as to form an integrated device). The image acquisition system and display can be on the same or different (e.g., opposing, orthogonal, etc.) sides of the housing. In a second specific example, the image acquisition system and display can each have a separate housing. However, the system can otherwise be housed, mounted, or configured.

### 4. Method.

The method 20 preferably functions to generate an augmented lightfield image (e.g., still lightfield images, frames of a lightfield video, etc.). The method and/or steps thereof can be performed automatically (e.g., upon receipt of a lightfield image or views thereof), manually (e.g., responsive to inputs from a viewer, user, etc.), semiautomatically (e.g., responsive to a trigger or other input), or be otherwise performed. The method and/or steps thereof can be performed in real- or near-real time (e.g., substantially concurrently with image acquisition; concurrently with lightfield image display; at a frame rate that is at least 10 fps, 20 fps, 24 fps, 25 fps, 30 fps, 60 fps, 100 fps, 120 fps, etc.; etc.), delayed, offline, and/or with any suitable timing. In an illustrative example, the method can be performed in real-time during a teleconference between two or more users (e.g., to augment a lightfield image of one user displayed to the other user). The method is preferably performed by a system as disclosed above, but can be performed by any suitable system.

The lightfield image is preferably represented by a plurality of views (e.g., still images such as arranged in a quilt image, in a format as disclosed in US Patent Application No. 17/226,404 titled ‘SYSTEM AND METHOD FOR GENERATING LIGHTFIELD IMAGES’ filed 09-Apr.-2021 incorporated in its entirety by this reference), each view associated with a different perspective (e.g., different spatial perspective, different in time, collected from a different angle, collected from a different position, etc.) of a scene (e.g., subject, object, etc. in the scene). However, the lightfield image can be represented by a three-dimensional representation (e.g., polygon, mesh, etc.) and/or in any manner. The lightfield image can be a still image, a frame of a lightfield video, a computer-generated image, and/or any suitable image. In variants of the method when the lightfield image is a frame of a lightfield video, each frame of the lightfield video can be augmented (e.g., with the same or different augmentation content), a subset of frames can be augmented (e.g., predetermined frames, selected frames, while augmentation is requested, etc.), and/or any suitable frames can be augmented. The frames can be augmented in the same or different manners (e.g., using the same augmentation content, using different augmentation content, in the same manner, in a different manner, etc.).

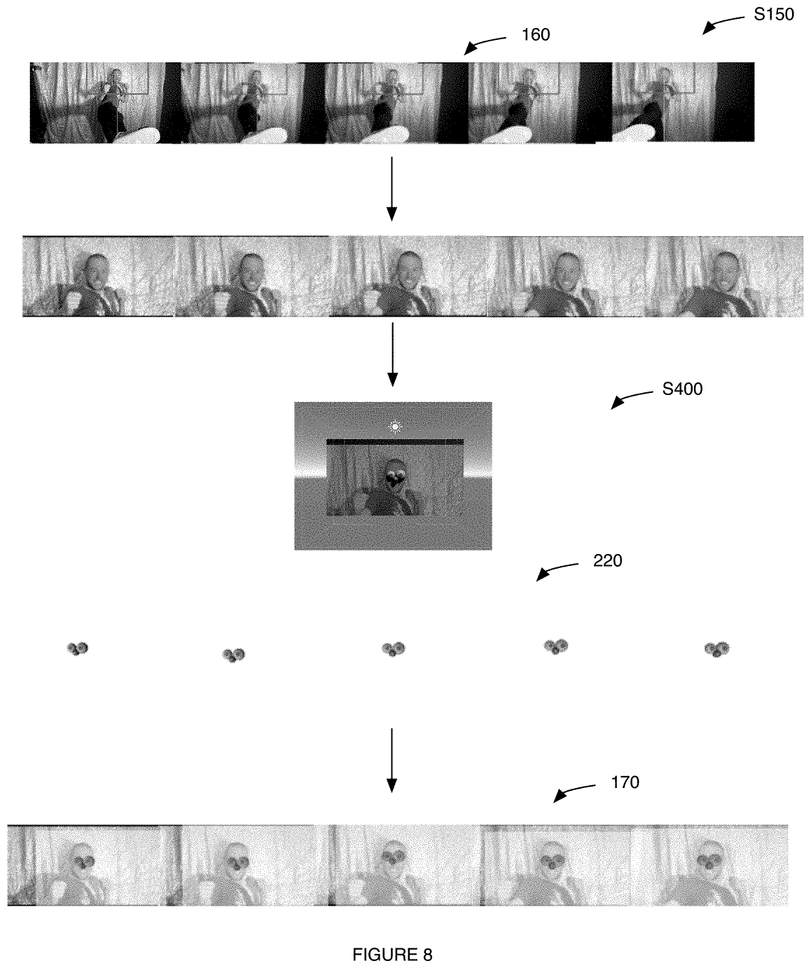

Receiving a lightfield image S100 functions to receive views associated with (e.g., used to generate) a lightfield image. The views 165, 165′ preferably includes a plurality of images of a scene (e.g., including one or more subject), where each image of the plurality shows a different perspective of the scene (e.g., subject, object, etc.). However, the views can be otherwise defined. In variants, the views can be formatted as a quilt image (e.g., a single image wrapper can include the views, as shown for example in FIG. 8). However, one or more views can be in a separate image wrapper and/or the views can be formatted in any manner. S100 can include acquiring the views (e.g., using an image acquisition system), retrieving the views (e.g., from a computing system such as from a database, storage, etc.), and/or include any suitable steps. The views can be processed (e.g., preprocessed to correct for artifacts, color effects, crop, transformations, etc.) or raw (e.g., unprocessed).

The received views preferably include a common region of interest (e.g., a common subject, shared feature, common feature, etc.). The received views are preferably aligned (e.g., processed) such that the region of interest is centered on and/or shares common horizontal or vertical pixel position between the views (e.g., such that the region of interest within different views has near-zero disparity). However, the received views can be unaligned.

In some embodiments (particularly but not exclusively beneficial when the received views are not aligned), the method can include aligning the images S150, which can function to set a region of interest (e.g., a subject, a feature, an object, etc.) to the focal plane of the display. Aligning the images can include: identifying the region of interest (e.g., subject, object, feature, etc. for example using a subject recognition algorithm, machine learning algorithm, feature detector, feature detection engine, etc.), transforming the image (e.g., cropping the images, translating the images, rotating the images, interpolating between images, extrapolating from images, etc.) such as to set the region of interest (or a portion thereof) to a near-zero disparity position (e.g., same or nearly the same pixel position in each image; within less than a threshold pixel disparity such as sub pixel, 1 pixel, 2 pixels, 3 pixels, 5 pixels, 10 pixels, etc. disparity; etc.), and/or can be processed in any suitable manner. In a specific example, the method can include detecting a predetermined object within each view (e.g., using an object detector) and optionally detecting a set of object keypoints within each view (e.g., using keypoint detectors, such as eye detectors, nose detectors, face detectors, feature engines, etc.). In variations of this specific example, the detected object and/or object keypoints can remain at (e.g., be set to) a fixed (e.g., locked) focal distance (e.g., when presented on a display, between frames of a video, etc. such as a focal plane of the display). As an illustrative example, a region of interest or object can include a head region of a subject (e.g., a hear, face, hair, ears, eye, nose, mouth, neck, portions of a torso, etc.), where a feature of the subject (e.g., eyes, glabella, nose, mouth, ears, etc.) is aligned (e.g., set to the zero-disparity position). In a second specific example, the images can be aligned as disclosed in US Provisional Application No. 63/120,034, titled ‘SYSTEM AND METHOD FOR PROCESSING HOLOGRAPHIC IMAGES’ filed 01-Dec.-2020 and/or any patent application which claims benefit to or priority to said provisional application, each of which is incorporated in their entirety by this reference, However, the focal distance can vary, the detected object and/or object keypoints can have a variable or varying focal distance, and/or the focal distance can otherwise be set.

Determining augmentation content S200 functions to determine content to be included in the lightfield image. The augmentation content can be digital content (e.g., generated by a computer), analog content (e.g., from an image, scan, etc. of a real-world object, from a second lightfield image received in the same or a different manner as S100, etc.), and/or any suitable content. The augmentation content is preferably visual content, but can be any suitable content (e.g., audio content). The augmentation content can be flat (e.g., without depth, two-dimensional, etc.), simulate a three-dimensional figure (e.g., include depth cues such as shading, perspective, parallax, etc. without having actual depth), be three dimensional (e.g., include a depth, change over time, etc.), be four dimensional (e.g., have three spatial dimensions and change in time), and/or have any suitable dimensionality. The augmentation content can be in a foreground (e.g., in front of one or more regions of interest), a background (e.g., behind regions or objects of interest), span a foreground and background (e.g., have portions with an intermediate depth between a foreground and background, have portions that are in front of a subject and other portions behind the subject, etc.), have no depth, have a depth matching a region of interest (e.g., be at the same focal position as the subject, region of interest, etc.), and/or can have any suitable depth and/or portion of the image(s).

The augmentation content can be automatically determined (e.g., present preselected augmentation content to a viewer or subject; applied according to a computer selection; applied based on an image aspect such as background, location, subject activity, object, subject property, etc.; etc.) and/or manually determined (e.g., user or viewer selected). For example, augmentation content can be determined based on a classification of the lightfield image (or views thereof), based on a user preference (e.g., a subject preference to remove a background of the lightfield image, to correct an appearance of a subject, etc.), based on a viewer preference (e.g., a viewer preference for a given background, a viewer request for subject labeling, etc.), and/or otherwise be determined. The augmentation content can be determined by a local computing system (e.g., an image acquisition system computing system, a display computing system, etc.), a remote computing system (e.g., a cloud computing system, a server, etc.), and/or any suitable computing system.

The augmentation content can be pre-generated and retrieved from a computing system (e.g., a database or other storage module thereof), be generated on-the-fly (e.g., in real-time such as during augmenting the lightfield image or other steps of the method), and/or be generated with any suitable timing. The augmentation content can be user generated, viewer generated, computer generated (e.g., using a machine learning algorithm, using artificial intelligence, etc.), and/or be generated by any suitable person(s) or entity(s) (e.g., image acquisition system manufacturer, display manufacturer, computing system manufacturer, etc.).

The augmentation content can be transparent (e.g., to enable portions of the features or images beneath to be perceived through the augmentation content), opaque (e.g., preventing content behind the augmentation content from being perceived), translucent, and/or can have any suitable opacity.

In a first example, the augmentation content is a 3D geometric model, wherein the geometric model is projected into the views (e.g., using a virtual camera arranged in a position corresponding to the view's physical camera arrangement). In a second example, the augmentation content includes a set of views from different perspectives, wherein the augmentation content is selected from the set based on the view's camera arrangement, the object's pose relative to the camera, and/or otherwise selected. In a third example, the augmentation content includes flat content that is projected in substantially the same manner into each view (e.g., views have different perspectives but augmentation content does not depend on the view).

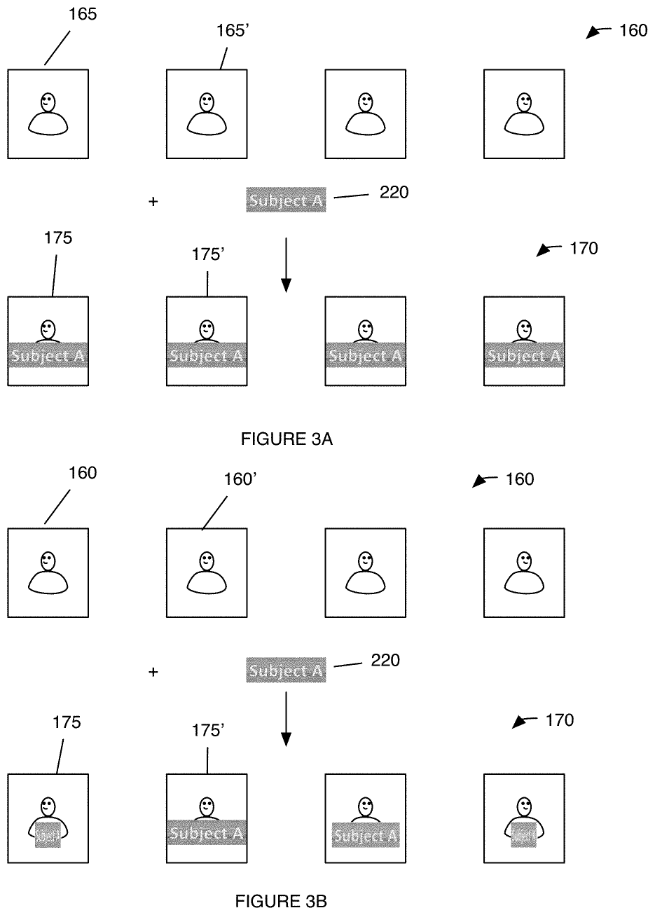

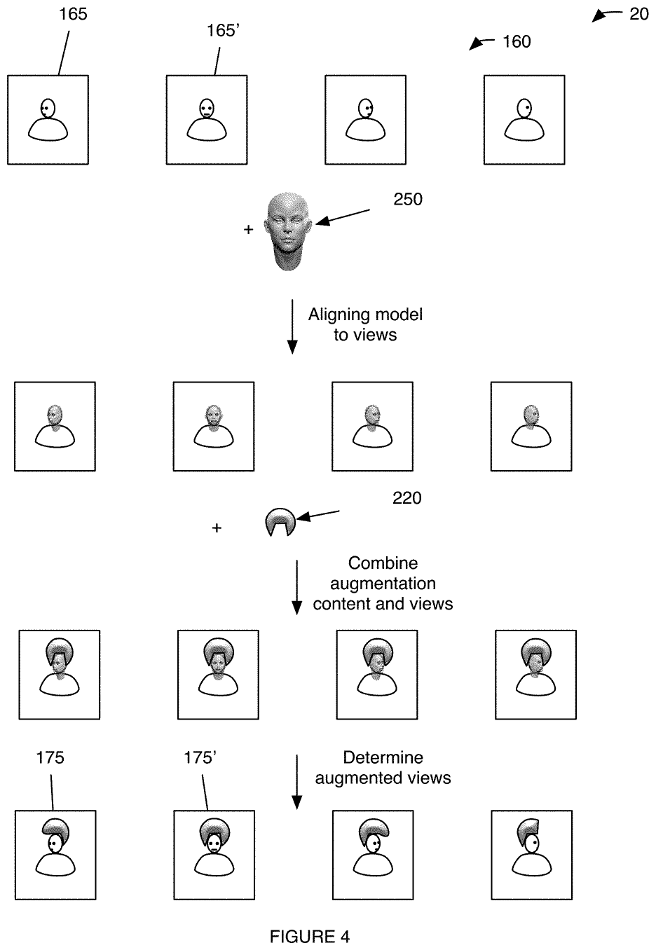

In an illustrative example, as shown in FIGS. 3A or 3B, flat (e.g., 2D, depthless, etc.) augmentation content can include a label (or other text). In a second illustrative example, as shown in FIG. 4, three dimensional augmentation content can include anatomical features or accessories (e.g., hair, wig, glasses, nose, lips, mouth, teeth, ears, earrings, nose rings, etc.). Other illustrative examples of augmentation content include: effects (e.g., change an environment such as appearance of weather, appearance of a background, blurring, pixelating, etc.), clothing (e.g., hats, glasses, shirt, tie, etc.), body parts (e.g., hair, limbs, whiskers, faces, etc. such as animal or human body parts), backgrounds, foregrounds, artificial objects, and/or can otherwise include any suitable content. However, any suitable augmentation content can be used.

In variants, more than one piece of augmentation content can be applied to a lightfield image. In these variants, when two or more augmentation contents overlap (e.g., are positioned such that at least a portion of each augmentation content is expected to be in the same location), a depth priority can be assigned to each augmentation content, each augmentation content can be rendered with a partial transparency (e.g., to facilitate perception of each augmentation content when applied and viewed through the display), augmentation content can be applied in a predetermined order (e.g., the order selected, based on a user or viewer preference, etc.), and/or the augmentation content can otherwise be handled.

When more than one region of interest (e.g., more than one subject, more than one object, etc.) is present, augmentation content can be selected for each region of interest, the regions of interest can be prioritized (e.g., where augmentation content can be applied depending on the prioritization), augmentation content can be applied to selected region(s) of interest (e.g., applied to one subject but not another subject), augmentation content can be applied to aligned region(s) of interest (e.g., to regions f interest in the focal plane of the display), augmentation content can be applied to non-aligned region(s) of interest (e.g., where the augmentation content is also blurry because it is off the focal plane, where the augmentation content can cause the region of interest to appear sharper despite being off the focal plane, etc.), and/or can otherwise be applied. For example, when two (or more) subjects are in a lightfield image, the same augmentation content can be applied to all subjects.

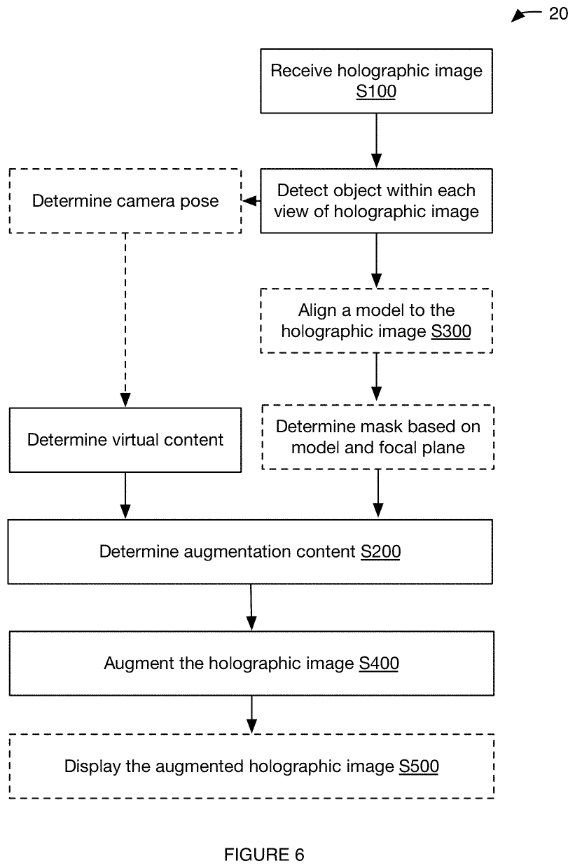

Aligning a model to the lightfield image S300 functions to align a model of a subject or feature of a scene to views of the lightfield image. This can additionally determine which portions of the subject are behind the focal plane (as shown for example in FIG. 6). The model (e.g., obscuring object) preferably functions in a manner similar to a clipping mask, where portions of the augmentation content behind the model are not included in the augmented lightfield image and portions of the augmentation content in front of the model are included in the augmented lightfield image. The model can additionally or alternatively be used to simulate or otherwise provide depth to the views and/or otherwise function. The model can be a polygon, a mesh (e.g., polygon mesh, triangular mesh, volume mesh, etc.), a subdivision surface, a level set, and/or have any suitable representation.

S300 can include determining the model. The model 250 can be determined automatically, manually (e.g., by a user or viewer, user generated, by a subject, etc.), and/or otherwise be determined. For example, the model can be determined based on an image classification (and/or a probability of a given classification of an object, subject, etc. within the image, region of interest, etc.). However, the model can additionally or alternatively be determined based on an application of the augmentation, based on a subject selection, based on a viewer selection, and/or in any manner. As an illustrative example, when the augmentation is being performed during teleconferencing, a human based model can be selected. The model can be pre-generated (e.g., retrieved from a computing system such as a database, storage module, memory, etc.), be generated on-the-fly (e.g., in real or near-real time), and/or otherwise be received or generated. However, the model can otherwise be determined.

The model can be generic (e.g., a universal model, a base model, etc.) or specific (e.g., to a scene, to a user, to a viewer, to a user characteristic, to a viewer characteristic, to a scene class, to a use case, to augmentation content, etc.). In a first specific example, the same model can be used for any human (e.g., a universal human model can be used such as a human model generated using MakeHuman). In a second specific example, a different model can be used for male and female subjects (e.g., where the class can be input by the viewer, subject, etc.; determined using machine learning or other image classification techniques; etc.). In a third illustrative example, the same model for different animal subjects (e.g., a generic animal model) can be used. In a fourth specific example, a different model can be used for different animals (e.g., a cat model can be used when applying augmentation content to a cat whereas a human model can be used when applying augmentation content to a human) or animal classes (e.g., mammal, amphibian, aquatic animal, avian, reptilian, fishes, insect, etc.; where a class can be determined as in the second specific example and/or in any manner). However, any suitable model can be used.

The model is preferably aligned to the corresponding subject (e.g., detected object) or region of the lightfield image (e.g., within each view of the lightfield image). The model is preferably centered on the corresponding aspect of the image, but can be off-center. For example, a corner, edge, side, point (e.g., keypoint), and/or other feature of the model can be aligned to a corresponding feature of the subject or region of the lightfield image. In some variants, to align the model to the subject or region of the lightfield image, the model can be transformed (e.g., scaled, translated, rotated, etc.) to match the subject or region of the lightfield image. For example, the model can be scaled such that the spacing between the eyes of the model (e.g., a universal human model) match the spacing of the eyes of a subject (e.g. and aligned such that the model eyes and subject eyes overlap). In another example, the model can be scaled such that the model head is approximately the same size (and/or shape) as the subject's head. However, one or more views can be transformed to match the model, and/or the model can otherwise be transformed and/or aligned to the views.

In a variant of aligning the model S440, the model can be aligned to a given view of the lightfield image. The orientation and/or position of the model with respect to the remaining views can then be determined based on a known arrangement between the remaining views and the given view. The known arrangement can be determined based on the perspective of the views, the camera orientations used to capture the views, and/or otherwise be determined. The alignment of the model can optionally be refined (for example by identifying and overlapping a feature of the lightfield image with the model) after determining an initial alignment based on the known relationship. However, the model can be aligned to one or more views independently (e.g., without using the known arrangement between views), and/or otherwise be aligned to the views.

The model is preferably used to draw or add depth to the lightfield image (e.g., views of the lightfield image). However, the model can otherwise be used. The model is preferably not directly included in the augmented lightfield image (e.g., the model is preferably not rendered). However, the model can be rendered (e.g., used to augment the lightfield image, incorporated into the augmentation content, etc.) included directly in the augmented lightfield image, and/or can otherwise be included.

The method can optionally include determining a clipping mask based on the model, wherein the clipping mask is used to edit (e.g., mask) the augmentation content. The clipping mask 252 can be 2D (e.g., specify whether to render a given pixel of the augmentation content), 3D (e.g., specify whether to render a pixel corresponding to a given voxel of the augmentation content), and/or have any other suitable set of dimensions. The clipping mask can be binary (e.g., render/do not render; in front of focal plane/behind focal plane; etc.), continuous (e.g., define depths or positions; define colors), and/or otherwise characterized. The clipping mask can be: an image mask, a shader (e.g., pixel shader, vertex shader), and/or otherwise constructed. For example, the clipping mask can be a masking shader that draws a depth buffer (e.g., but does not render any content), which specifies the pixels that are in front of vs. behind the subject.

The clipping mask is preferably dynamically determined (e.g., based on the object detected in the view), but can be predetermined (e.g., based on the camera position within the lightfield array, based on the subject, based on the scene, etc.) and/or otherwise be determined. The clipping mask can be determined based on the model alignment with the subject in the view (e.g., the detected object), based on the focal plane of the source camera (e.g., determined from the camera's parameters), and/or determined based on other information. For example, the clipping mask can be determined based on the object-aligned model and the focal plane, wherein the clipping mask specifies which regions of the object-aligned model fall behind the focal plane (or which regions of the object-aligned model fall in front of the focal plane).

In a specific example, generating the clipping mask includes: aligning the model with the detected object in the view, determining the portions of the model falling behind the focus plane of the view (and/or falling in front of the focus plane), and generating a masking shader (e.g., configured to draw a depth buffer 255) based on the portions of the model falling behind/in front of the focus plane.

Augmenting the lightfield image S400 functions to generate the lightfield image with the augmentation content. The lightfield image is preferably augmented using a computing system (e.g., remote computing system, display computing system, image acquisition system computing system, etc.), but can be augmented using any suitable system. S400 can be performed before, during, and/or after S300.

The lightfield image is preferably augmented without using depth information (e.g., without determining depth information associated with the lightfield image, without using depth information associated with the lightfield image such as acquired using a depth sensor, etc.), which can be beneficial for decreasing necessary processor power for augmenting the lightfield image (e.g., because depth determination can be a computationally expensive and/or slow process). For example, the lightfield image can be augmented in an image-based representation (e.g., where the lightfield image is represented as a plurality of views rather than in a three-dimensional representation). However, depth information can be used (e.g., using depth information determined using a depth sensor) and/or determined (e.g., using stereoscopic methods, artificial intelligence, etc.).

S400 can include obscuring augmentation content S480, overlaying (e.g., combining) the augmentation content and the lightfield image (e.g., views thereof) S460, transforming the augmentation content (e.g., scaling, translating, rotating, affine transformation, warping, distorting, etc. such as based on a measured, estimated, calculated, etc. feature size, display focal plane, distance between feature and focal plane, etc.), rendering the augmentation content S490, and/or any suitable processes or steps.

Augmenting the lightfield image can includes combining the lightfield image and the augmentation content. For example, augmenting the lightfield image can include: overlapping the views of the lightfield image with the augmentation content (e.g., by aligning the augmentation content to the subject and/or a feature of the lightfield image), generating virtual views using a set of virtual cameras (e.g., with properties such as capture angle, focal plane, orientation, etc. determined, for instance, based on properties of the image acquisition system used to acquire the views, rendering virtual views) where the virtual views can include the original views (potentially from modified perspectives) and the augmentation content, rendering virtual views of the augmentation content and overlapping the virtual views and the lightfield image views (e.g., views sharing a common perspective), and/or otherwise combining the lightfield image (or views thereof) and the augmentation content.

In some variations, the virtual camera parameters can be determined based on the pose of the image acquisition system (or a camera thereof). For instance, for a real-world camera view the method can include: calculating the (approximate) pose of a subject (e.g., a set of rotations such as one for each axis, of the subject relative to the camera used to capture the view) and setting parameters (e.g., properties) of the virtual render S445 (e.g., virtual camera) based on the calculated pose. For example, a subject's head pose can be calculated and used to determine the virtual camera parameters. Examples of the virtual camera parameters include the rotation of the virtual camera relative to the subject (such as based on or relative to the rotation of a master view, center view, etc.) the capture angle of the virtual camera (such as rotation of a leftmost view to a rotation of a rightmost view; and/or any suitable parameters), and/or any suitable parameter(s). However, any suitable features or aspects of the image can be used, the virtual camera parameters can be predetermined (e.g., calibrated and known), the virtual camera can use the real image acquisition system pose (e.g., relative camera poses), and/or the virtual camera parameters can be set in any manner.

The augmentation content can be applied to the lightfield image: regardless of a depth to the subject and/or augmentation content, based on a model (e.g., as applied to the lightfield image or views thereof in S300), based on a depth to the subject or scene (or features thereof), based on a 3D representation of the lightfield image (e.g., a three dimensional recreation of the scene such as derived from the set of views), and/or based on or using any suitable information. The augmentation content can be applied to each view of the lightfield image, to the lightfield image (e.g., a 3D model or 3D representation of the lightfield image or features thereof), to a subset of views of the lightfield image (e.g., to augment the lightfield image from some perspectives but not others), and/or can be applied to any suitable views. The augmentation content can appear the same from different perspectives (e.g., flat augmentation content) and/or different from different perspectives (e.g., be obscured, be aligned to different portions of the scene, have an appearance of depth, etc.). For instance, the augmentation content can be obscured differently in different views based on an expected extent of the augmentation content to be perceived around a feature. In an illustrative example, a lightfield image can be augmented with a background (e.g., digital background) where different portions of the background can be perceived in different views. In another illustrative example, augmentation content can be applied to a region (e.g., a head region) of a subject, where different portions of the augmentation content are perceived in the augmented lightfield image based on the different perspectives (e.g., portions of the augmented content being perceived as obscured by the subject). However, the augmentation content can otherwise be perceived.

S400 preferably includes determining (a location of) a feature S420 (e.g., a subject, a feature of a subject, etc.) within the lightfield image. The feature can be determined manually (e.g., be selected, identified, etc. by a user, subject, viewer, etc.), using artificial intelligence (e.g., a neural network), using image segmentation methods, using feature detection methods, and/or otherwise determining the feature. Determining the feature (e.g., a position of the feature) functions to identify where augmentation content should be placed within the lightfield image. For instance, the augmentation content can be a pair of glasses that should be aligned to an eye of a subject of the lightfield image. However, the positioning of the augmentation content can otherwise be determined.

In a first embodiment, the lightfield image can be augmented without using a model. This embodiment is particularly, but not exclusively, used when applying flat augmentation content and/or augmenting the lightfield image with augmentation content that sits in the foreground (e.g., would not be occluded by anything within the scene).

In an illustrative example of the first embodiment, augmentation content can be placed proximal (e.g., over, within a threshold distance such as a threshold number of pixels from an edge of, etc.) a feature (e.g., a subject's head region) based on the approximate z-position (e.g., within ±1, ±₅, ±10, ±20, ±100, etc. pixels) of the feature (such as to label the subject, to identify the subject, etc.). In this illustrative example, the views and the augmentation content can be combined by: rendering a lightfield (e.g., a quilt image) of the augmentation content (e.g., with a transparent background, without a background, etc.; with a similar angular baseline as the views such as from perspectives approximating the view perspectivesl; etc.); and adding the quilt image of the augmentation content to the views (e.g., represented as a quilt image—i.e., the received lightfield image). In this example, the augmentation content can be aligned to the lightfield image using an alignment tool. An exemplary alignment tool can include a 2D quad at the virtual focal plane of the virtual camera(s), and one view of the subject can be placed on (e.g., centered on, approximately centered on, etc.) the quad. Having the subject at the focal plane (e.g., when the views are aligned such that the subject has near-zero disparity) can enable or facilitate alignment of the augmentation content to the subject (particularly in other views, without using an alignment tool for each view, etc.). Alternatively phrased, the augmentation content can be aligned to a single view of the lightfield image where augmentation content can be applied to the other views based on a known perspective, relationship, pose, alignment, etc. between the augmentation content-aligned view and the other views. However, in a related variation of this specific example, each view of the set of views of the lightfield image can be aligned to the respective perspective of the augmentation content (e.g., using a 2D quad, using an alignment tool, etc.) and/or any subset of views can be aligned to the augmentation content. However, the augmentation content can otherwise be applied to the lightfield image.

When flat augmentation content is applied, the augmentation content can appear the same from different perspectives (e.g., same size, same width, as shown for example in FIG. 3A, etc.) and/or can appear different from different perspectives (e.g., in different views of the augmented lightfield image such as to have a greatest width in a central perspective and appear thinner from other perspectives, to have a greatest width in an extreme perspective and thinner width for other perspectives, to have a thinnest width in a perspective and become wider for other views, as shown for example in FIG. 3B, etc.).

In a second embodiment, the lightfield image can be augmented using the model (e.g., a model as described and applied to the lightfield image and/or views thereof as described in S300). In the second embodiment, the model can function, for example, as a clipping mask, indicating portions of the augmentation content that should not be rendered or included in the displayed augmented lightfield image.

In an illustrative example of the second embodiment, a lightfield image or view thereof can include a model (e.g., as disclosed in S300). The augmentation content can be applied or layered onto the lightfield image or view thereof. The augmentation content can be applied before, after, or concurrently with the model. In this specific example, the model and augmentation content can each be associated with a depth. When a portion of the augmentation content is behind the model (e.g., depth or distance to the augmentation content is greater than or equal to the depth or distance to the model), that portion of the augmentation content can be hidden, removed, cropped, opacity set to o, transparency set to o, and/or otherwise not be rendered. When a second portion of the augmentation content is in front of the model (e.g., depth or distance to the augmentation content is less than or equal to the depth or distance to the model), the second portion of the augmentation content can be rendered or otherwise included in the augmented lightfield image. However, portions of the augmentation content behind the model can be included in the augmented lightfield image, portions of the augmentation content in front of the model can be excluded from the augmented lightfield image, and/or any suitable information can be included or excluded from the augmented lightfield image.

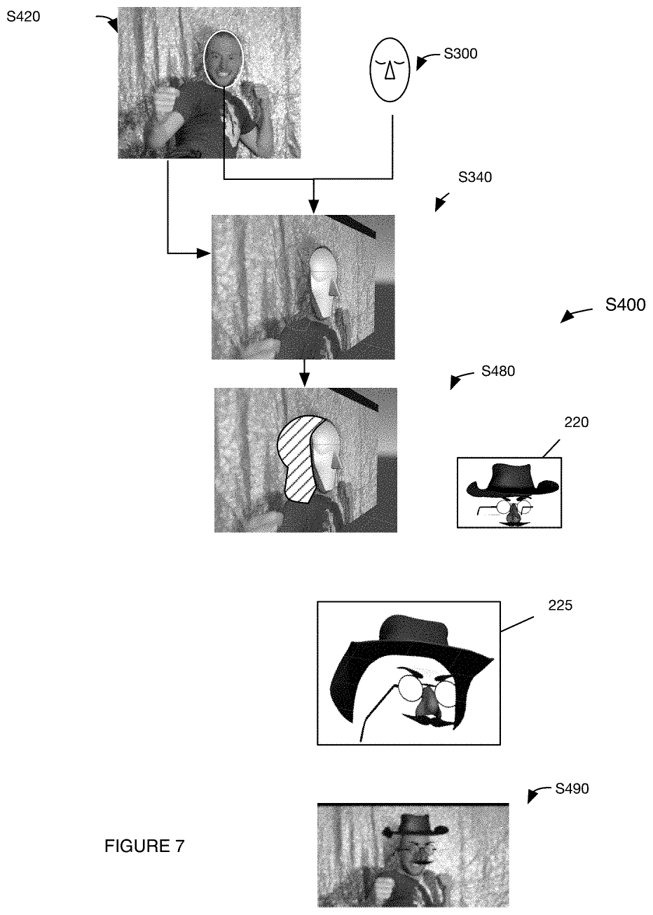

In a third embodiment as shown for example in FIG. 7, the lightfield image can be augmented using the clipping mask (e.g., a clipping mask defined by the model, a clipping mask associated with the model, etc.). In this embodiment, the method can include: editing the augmentation content for the view based on the clipping mask (which functions to create view- and object-pose specific augmentation content), and overlaying the edited augmentation content over the respective view. Editing the augmentation content for the view can include: rendering all portions of the augmentation content for the view (e.g., on a transparent background, in a layer separate from the view) except for those portions specified by the clipping mask. Additionally or alternatively, editing the augmentation content for the view can include rendering the augmentation content, then masking out the portions of the object behind the focus plane using the clipping mask. However, the augmentation content can be otherwise edited. The resultant layer, including the edited augmentation content and optionally a transparent background, can then be aligned with the view (e.g., using the detected object, detected keypoints, view coordinates, etc.) and overlaid over the view.

However, the augmentation content can be obscured or otherwise be hidden or not rendered based on a depth of the lightfield image (e.g., determined from a disparity map between two or more views, determined from a depth camera used to capture the view, determined using a depth sensor registered with the image acquisition system or portion thereof, etc.) and/or otherwise be included in or excluded from the lightfield image.

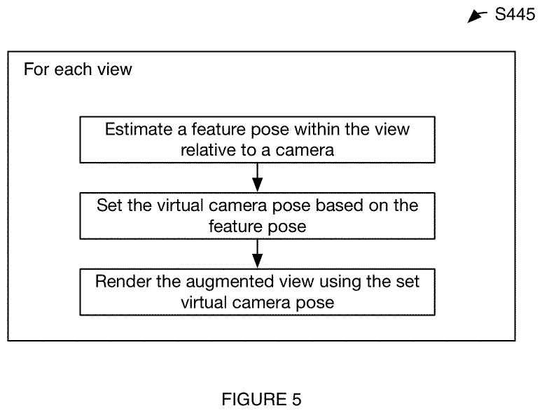

S400 can optionally include refining the augmented lightfield image, which can be beneficial when the augmentation content is not aligned (or not well aligned) to the scene or a subject thereof of in the lightfield image. Misalignment of the augmentation content can be detected (and/or identified or input) manually (e.g., by a user or viewer) and/or automatically detected (e.g., using machine vision, artificial intelligence, edge detection, image mismatch, etc.). In some variants, portions of the augmentation content can be modified (e.g., expanded, shrunk, rotated, etc.) or aligned to refine the augmented lightfield image. For instance, a portion of the augmentation content can be rendered a second time (e.g., with a different geometry) based on a subject's pose within the lightfield image. In an illustrative example as shown in FIG. 5, refining the augmented lightfield image can include: for each view of the lightfield image: determining an estimated feature (e.g., subject, region of interest, etc.) pose (e.g., a set of rotations of the subject relative to the camera), using the estimate feature pose(s) to set the parameters of the virtual render (e.g., the rotation of the virtual camera relative to the subject, for instance based on the rotation of the center view, and the capture angle of the virtual lightfield such as the rotation of leftmost view and the rotation of rightmost view), and determining the augmented views. However, the augmented lightfield image can otherwise be refined.

When two or more features (e.g., subjects) are present, the augmentation content can be applied to all features, a subset of features (e.g., selected features, primary features, secondary features, features in a focal plane, etc.), a single feature, and/or to any suitable features. The augmentation content can be applied in the same or different manner for each feature. For example, a feature or features on or near (e.g., within a threshold depth of) the focal plane of the display can have augmentation content that is applied using a model or clipping mask while a feature or features far from (e.g., greater than a threshold depth from) the focal plane can have

However, the lightfield image can otherwise be augmented.

Displaying a lightfield image S500 functions to display a lightfield image to one or more viewers. S500 preferably displays the lightfield image as generated in S400 (e.g., the augmented lightfield image), but can display any suitable images. The lightfield image is preferably viewable without using peripherals (e.g., headsets, glasses, etc.). However, the lightfield image can be viewable using peripherals. S500 preferably occurs after S400, but can occur before and/or at the same time as S400. S500 is preferably performed by a display, but can be performed by a computing system and/or any suitable system. The lightfield image is preferably perceived as a 3D representation of the scene (e.g., subject of the lightfield image), but can be perceived as a 2D representation of the scene and/or any suitable representation of the scene. The lightfield image is preferably perceived as three dimensional by more than one viewer (e.g., 2, 3, 4, 5, 10, 20, 100, values therebetween, >100 viewers), but can be perceived as three dimensional for a single viewer and/or any suitable viewers.

S500 can include aligning the views of the lightfield image (e.g., the augmented lightfield image) to the display (e.g., associating or assigning pixels of each view to pixels of the display). The alignment of the views can be referred to as lenticularizing the views. The views are preferably aligned based on a calibration (e.g., a pitch, center, slope of a lenticular, etc.) of the display, but can otherwise be aligned to the display.

S500 can include presenting audio content (e.g., audio content acquired concurrently with image acquisition) such as to enable telecommunications (e.g., one way communication, two-way communication, multi-party communication, etc.) between subject(s) and viewer(s).

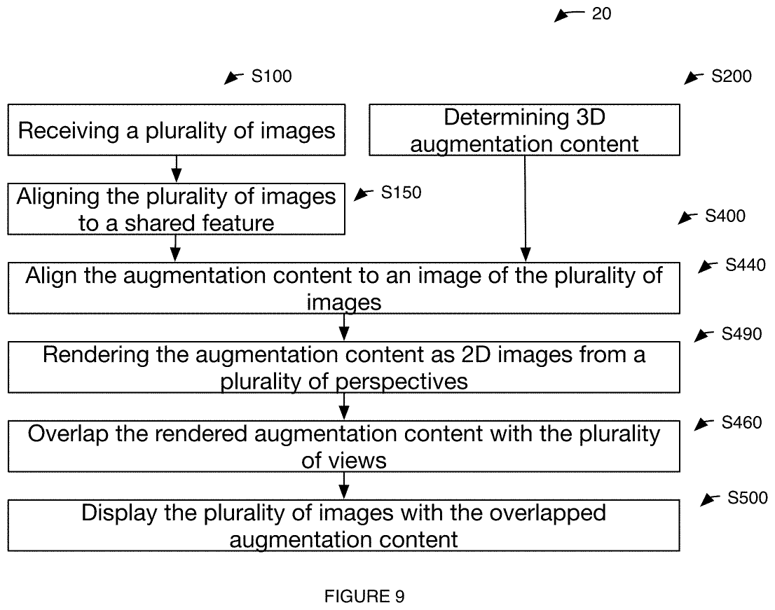

In a first specific example, as shown for example in FIGS. 8 and 9, a method can include: receiving a set of images of a subject, aligning each image of the set of images to a common region of interest (e.g., such that the subject appears on a display focal plane when the images are displayed on a lightfield display), determining augmentation content, aligning the augmentation content to a feature of an image, rendering the augmentation content in a plurality of perspectives (e.g., perspectives matching the perspectives of images of the set of images), and overlaying the augmentation content on the set of images to form an augmented lightfield image.

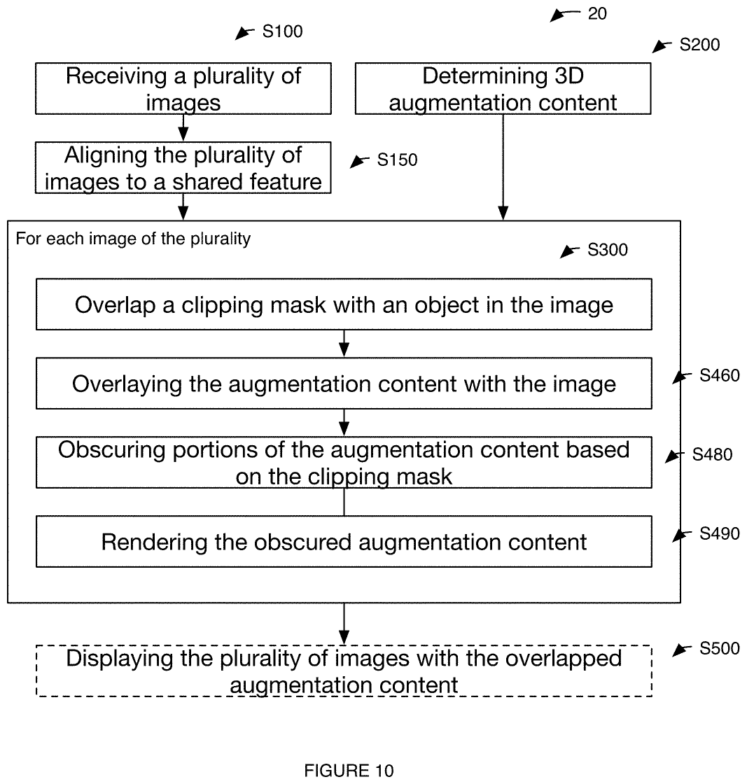

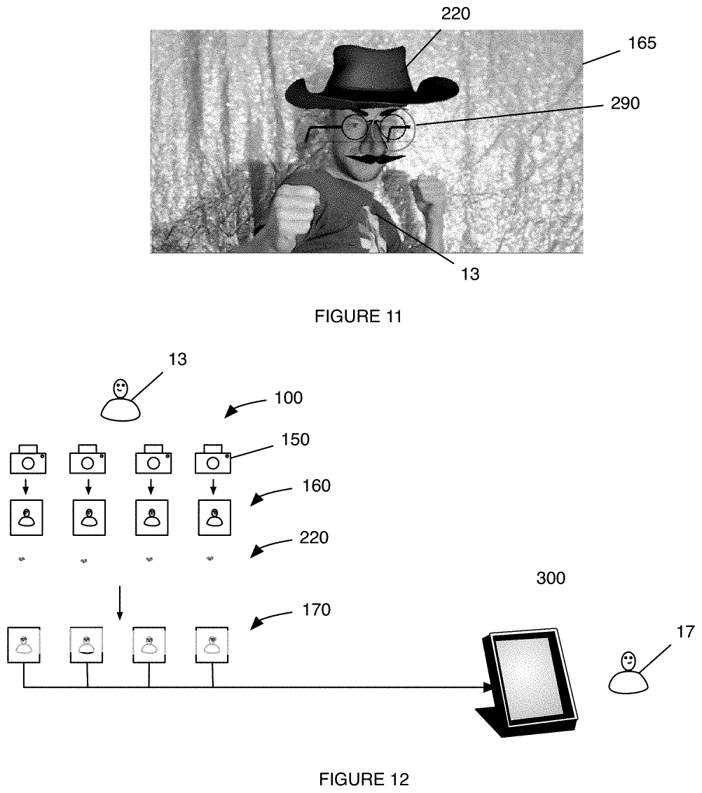

In a second specific example, as shown for example in FIG. 10, a method can include: receiving a plurality of images; aligning the plurality of images to a region of interest (e.g., such that the subject appears on a display focal plane when the images are displayed on a lightfield display); determining augmentation content; for each image of the plurality of images: overlapping a model (e.g., a clipping mask, depth shader, obscuring object, etc.) with a feature of the image, aligning the augmentation content to the feature, obscuring portions of the augmentation content based on the model, and rendering the obscured augmentation content; and optionally, displaying the augmented lightfield image (e.g., the plurality of images with the obscured augmentation content). In a variation of the second specific example, the model can be aligned using a single image, where the model can be used to obscure (e.g., identify portions of the augmentation content to hide, not to render, etc. during augmentation content rendering) the augmentation content in each perspective (e.g., only aligning the model once, using a single alignment to set the perspective, etc.).

The methods of the preferred embodiment and variations thereof can be embodied and/or implemented at least in part as a machine configured to receive a computer-readable medium storing computer-readable instructions. The computer-readable medium can be stored on any suitable computer-readable media such as RAMs, ROMs, flash memory, EEPROMs, optical devices (CD or DVD), hard drives, floppy drives, or any suitable device. The computer-executable component is preferably a general or application specific processor, but any suitable dedicated hardware or hardware/firmware combination device can alternatively or additionally execute the instructions.

Embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the preferred embodiments of the invention without departing from the scope of this invention defined in the following claims.

We claim:

1. A method for augmenting a lightfield image comprising:
receiving a plurality of images of a subject, wherein each image of the plurality of image is associated with a different perspective of the subject;
aligning each image of the plurality of image to a shared feature;
for an image of the plurality of images:
overlaying augmentation content on the image;
obscuring portions of the augmentation content based on the perspective of the image and the subject, wherein the portions are obscured without determining depth information associated with the subject; and
rendering the obscured augmentation content with a plurality of perspectives based on the perspectives associated with the images of the plurality of images; and
displaying the aligned images and the obscured augmentation content at a holographic display.

2. The method of claim 1, wherein the augmentation content comprises a digital background.

3. The method of claim 1, wherein obscuring portions of the augmentation content in an image of the plurality of images comprises:
aligning an obscuring object to a portion of the image;
apply a masking shader to the obscuring object; and
masking the augmentation content using the masking shader.

4. The method of claim 3, wherein the obscuring object comprises a standard model of a virtual head, wherein the obscuring object is aligned to a head region of the subject within the image.

5. The method of claim 3, wherein applying the masking shader to the obscuring object comprises applying a depth buffer to the obscuring object without rendering the obscuring object.

6. The method of claim 3, wherein augmentation content is applied to the image before the obscuring object.

7. The method of claim 1, wherein aligning each image of the plurality of images comprises:
determining a location of the shared feature in each image; and
setting the location of the shared feature to a near zero disparity.

8. The method of claim 7, wherein aligning each image of the plurality of images comprises, for each image:
determining a bounding box surrounding the shared feature in the respective image; and
cropping the respective image based on the bounding box.

9. The method of claim 7, wherein the shared feature is determined using machine learning techniques.

10. The method of claim 1, wherein the augmented lightfield image is displayed contemporaneously with receiving the plurality of images.

11. A system for generating an augmented lightfield image of a subject comprising:
an image acquisition system comprising a plurality of cameras with overlapping fields of view, wherein the plurality of cameras are operable to acquire a plurality of images of a scene; and
a processor configured to:
align each image of the plurality of images to a shared feature; and
for an image of the plurality of images:
overlay augmentation content on the image;
obscure portions of the augmentation content behind the shared feature, wherein the portions are obscured without determining depth information associated with the shared feature; and
render the obscured augmentation content;
wherein the augmented lightfield image comprises the plurality of images and the rendered augmentation content.

12. The system of claim 11, further comprising a display configured to display the augmented lightfield image, wherein the augmented lightfield image is perceivable as three-dimensional without the use of a peripheral device.

13. The system of claim 12, wherein the display comprises:
a light source;
a lenticular lens optically coupled to the light source that, with the light source, generates a light output having viewing angle dependency; and
an optical volume optically coupled to the lenticular lens.

14. The system of claim 11, wherein the processor is configured to obscure the portions of the augmentation content in an image of the plurality of images by:
aligning an obscuring object to the image;
apply a masking shader to the obscuring object; and
masking the augmentation content using the masking shader.

15. The system of claim 14, wherein the obscuring object comprises a universal model of a virtual head, wherein the obscuring object is aligned to a head region of a subject within the image.

16. The system of claim 14, wherein applying the masking shader to the obscuring object comprises applying a depth buffer to the obscuring object, wherein the augmentation content is rendered without rendering the obscuring object.

17. The system of claim 14, wherein the processor overlays the augmentation content on the image before the obscuring object.

18. The system of claim 11, wherein the processor aligns each image of the plurality of images by:
determining a location of the shared feature in each image; and
setting the location of the shared feature to a near zero disparity.

19. The system of claim 18, wherein the processor aligns each image of the plurality of images by, for each image:
determining a bounding box surrounding the shared feature in the respective image; and
cropping the respective image based on the bounding box.

20. The method of claim 18, wherein the processor determines the shared feature using machine learning.
